(19) United States
(12) Patent Application Publication
(10) Pub. No.: US 2018/0210612 A1
(43) Pub. Date: Jul. 26, 2018

(54) SYSTEM AND METHOD FOR ADVERTISEMENT DISPLAY ON MOBILE DEVICES

(71) Applicant: AD CLOUD COMPANY LIMITED, Wainuoiomata, Lower Hugg (NZ)

(72) Inventors: ANASTASSIYA LYUBICH, Wainuoiomata, Lower Hugg (NZ); VLADIMIR DOLGOV, Wainuoiomata, Lower Hugg (NZ)

(73) Assignee: AD CLOUD COMPANY LIMITED, Wainuoiomata, Lower Hugg (NZ)

(21) Appl. No.: 15/746,725

(22) PCT Filed: Jul. 22, 2016
(86) PCT No.: PCT/NZ2016/050117

§ 371 Date: Jan. 22, 2018

(30) Foreign Application Priority Data
Jul. 22, 2015 (NZ) 710320

(51) Int. Cl. G06F 3/0481; G06Q 30/02; G06F 3/0488

(52) U.S. Cl. CPC G06F 3/0481; G06F 3/0488; G06Q 30/0267

(57) ABSTRACT

The invention relates to a system and method of utilising live wallpaper on a mobile device, particularly for advertisement purposes. The system and method are operable to provide dynamic, animated and interactive advertising to mobile computing devices. The advertising is specifically targeted at the user of the mobile device and is presented to the user as live wallpaper when the device is active or as a screensaver when the device is in charging state.

### FIELD OF THE INVENTION

The invention relates to a system and method of utilising live wallpaper on a mobile device and in particular to the use of live wallpaper for advertisement purposes.

### DISCUSSION OF THE PRIOR ART

Advertising services on mobile devices is rapidly gaining popularity. Mobile devices are an ideal marketing platform in part due to the frequency of user engagement.

Marketing campaigns for mobile devices are popular and many software products use advertising banners as a way to monetize. However, banners on a mobile device have shortcomings because they are often small, contain very basic advertisement data and shrink the ad to fit in an application or browser. Banners on a mobile device rarely attract user attention or excite marketers.

Video advertising is gaining popularity for use with mobile devices. However, video advertising has disadvantages of limited control over the amount of data that is transferred. A further disadvantage is that there is limited opportunity for a user to interact with displayed video content. A further disadvantage is that there are often no mechanisms to ensure data is not transferred when a user is charged for data or where roaming charges may apply.

Pop-up advertising banners and messages built in mobile applications are another form of advertising on a mobile device. However, pop up messages or banners usually cover only a portion of the screen or the whole screen of a mobile device are generally perceived as intrusive and a nuisance to users. Pop up banners are often closed instantly by a user without the content being reviewed.

Another form of advertising on a mobile device is to display passive static advertising on the home screen of a mobile device. However, this has disadvantages of requiring special gadgets to be installed on a display of the mobile device to enable a user to interact with the advertisement.

Another form of advertising on a mobile device is to use the lock screen as a personal advertising billboard by installing a special application to display advertisements on the lock screen when the mobile device is locked. The application is often interactive and that allows a user to jump to the ad associated web page if they wish to do so. Users are usually rewarded for hiring out their lock screen for advertising. However, there are several disadvantages to lock screen advertising. For example, during the day when the mobile device is not used it is actually in a sleeping mode and the screen is off. The lock screen is activated only when a user is trying to activate the mobile device and then it is displayed until the user unlocks the device by either entering their PIN code, swiping the screen, drawing an unlock pattern or similar methods. The advertisement is usually shown briefly. The incentive users get in a form of a reward is usually tied to the time users spend on viewing the advertisement, which is minimal. Further, there is no guarantee that the user will interact with the displayed advertising content and even that this ad experience can be considered as an impression since often people unlock their device quickly. While application developers want to generate as many impressions as possible, advertisers look for guaranteed views.

It is an object of the invention to go at least some way toward overcoming or at least ameliorating some of the abovementioned disadvantages or to at least provide the public with a useful choice.

### SUMMARY OF THE INVENTION

In one broad aspect the invention consists in an interactive advertising content system comprising: a mobile device having a display, a memory component and a processor configured to execute instructions stored on the memory component, a server having a processor and a memory component, the server memory component configured to store a plurality of advertising content comprising visual objects, one or more interaction objects, and data pertaining to a target recipient user for the advertising content,

the server memory component further configured to store instructions for execution by the server processor operable to: receive user data pertaining to the user of the mobile device for storage on the server memory component, determine, from the received user data, advertising content where the target recipient data matches the user data, and transmit determined advertising content to the user mobile device,

wherein the mobile device is configured or configurable to receive and store the transmitted advertising content on the mobile device memory component, and wherein the instructions stored on the mobile device comprise: configuring the display to implement a plurality of visual layers, retrieve one or more advertising content stored in the memory of the mobile device, and display the advertising content on a lowest layer of the visual layers.

In another broad aspect the invention consists in an interactive advertising content system comprising: at least one memory component and at least one processor configured to execute instructions stored on the memory component, wherein the at least one memory component is configured to store a plurality of advertising content comprising visual objects, one or more interaction objects, and data pertaining to a target recipient user for the advertising content, the at least one memory component further configured to store instructions for execution by the at least one processor operable to: receive user data pertaining to the user of a mobile device for storage on the memory component, determine, from the received user data, advertising content where the target recipient data matches the user data, and transmit determined advertising content to the user mobile device for display as one of a plurality of visual layers, wherein the advertising content is configured for display on a lowest visual layer.

In another broad aspect the invention consists in a mobile device comprising a display, a memory component and a processor configured to execute instructions stored on the memory component, the mobile device configured to receive a plurality of advertising content for display comprising visual objects, one or more interaction objects, and data pertaining to a target recipient user for the advertising content, wherein the mobile device is configured or configurable to display a plurality of visual layers, and the advertising content is adapted for display on a lowest layer of the visual layers.

In some embodiments, the interaction object is configured for display on the lowest visual layer.

In some embodiments, the instructions for execution further comprise instructions operable to receive a signal input indicative of a user interacting with an interaction object and, in response, initiate one or more response actions.

In some embodiments, the display is touch and position sensitive and a user touch in the position of the interaction object is indicative of a user interacting with an interaction object.

In some embodiments, a response action comprises one or more of opening a web browser and directing to a predetermined website, showing detailed information about the object of interest, adding a selected advertisement to a list of favourites and rating the visual representation of the displayed advertisement.

In some embodiments, the advertising content is stored in a library of advertising content, and the instructions for execution further comprise instructions operable to store data pertaining to advertising content transmitted to the user device and, determining advertising content not transmitted to the user device for future transmission.

In some embodiments, the advertising content comprises at least one dynamic graphical object.

In some embodiments, the dynamic graphical object comprises graphical changes in one or more of: position, time period, transparency, scale, rotation, colour changing, shaking, sparkling, appearing, or disappearing.

In some embodiments, the lowest visual layer is a live wallpaper.

In another broad aspect, the invention is said to consist in a method for displaying animated advertising with a live wallpaper on a computing device, comprising:

displaying a live wallpaper, wherein the live wallpaper includes advertising background and at least one dynamic graphical object on a lowest visual layer of the display on a computing device using a plurality of specified attributes; and applying various animating effects to the object; and

updating the advertising background including displayed graphical objects in a regular time interval.

In some embodiments, the computing device is a mobile computing device which has an operating system.

In some embodiments, the computing device is a mobile computing device which has a Wi-Fi or a cellular data connection.

In some embodiments, the advertising background is a visual image that covers an entirety of the display of the mobile computing device and serves for the main purpose of advertising.

In some embodiments, the dynamic graphical object includes at least one of visual image, text, shape or symbol displayed in sequence or out of turn.

In some embodiments, the specified attribute includes at least one of position, time period, transparency, scale, or rotation.

In some embodiments, the animating effect is at least one of moving, colour changing, shaking, sparkling, appearing or disappearing.

In another broad aspect, the invention is said to consist in a method for using live wallpaper for engaging user interaction with the displayed advertisement on a mobile device, comprising:

displaying a wallpaper, wherein the wallpaper includes an advertising background and at least one dynamic graphical object on a lowest visual layer of the display on the computing device using a plurality of specified attributes; and

applying various animating effects to the object; and

engaging user interaction with the graphical objects in response to the user touching the screen of the mobile device

receiving a response from the graphical object, which upon detecting a user gesture, initializes on the display of the computing device a set of actions, including at least one of redirecting to the advertiser's website, showing detailed information about the object of interest, adding a selected advertisement to the favourites and rating the visual representation of the displayed advertisement.

In some embodiments, the computing device is a mobile computing device which has a touch screen and an operating system.

In some embodiments, the computing device has a Wi-Fi or a cellular data connection.

In some embodiments, the advertising background is a visual image that covers an entirety of the display of the mobile computing device and serves for the main purpose of advertising.

In some embodiments, the dynamic graphical object includes at least one of visual image, text, shape or symbol displayed in sequence or out of turn.

In some embodiments, the specified attribute includes at least one of position, time period, transparency or scale.

In some embodiments, the interaction includes at least one of moving, dragging or selecting a displayed dynamic graphical object or their combination thereof.

In another broad aspect, the invention is said to consist in a method for using interactive live wallpaper for displaying entertaining advertisements, comprising displaying a wallpaper, wherein the wallpaper includes an advertising background and at least one dynamic graphical object on a lowest visual layer of the display on a computing device using a plurality of specified attributes; and

applying various animating effects to the object; and

engaging user interaction with the graphical object in response to the user touching the screen of a mobile device in order to participate in an entertaining advertising activity.

In some embodiments, computing device is a mobile computing device which has a touch screen and an operating system.

In some embodiments, computing device has a Wi-Fi or a cellular data connection.

In some embodiments, the advertising background is a visual image that covers an entirety of the display of the mobile computing device and serves for the main purpose of advertising.

In some embodiments, the dynamic graphical object includes at least one of visual image, text, shape or symbol displayed in sequence or out of turn.

In some embodiments, the specified attribute includes at least one of position, time period, transparency, scale or rotation.

In some embodiments, the interaction includes at least one of moving, dragging or selecting a displayed dynamic graphical object or their combination thereof.

In some embodiments, the entertaining advertising activity includes at least one of a puzzle, a matching game or a guess game with advertisement-related content

In another broad aspect, the invention is said to consist in a method for automatically updating live wallpaper on the display of a computing device, wherein the live wallpaper includes advertising content, comprising:

installing a live wallpaper application on a computing device; and

setting the live wallpaper as a default wallpaper on the computing device;

automatically transmitting a signal from the application installed on a mobile computing device to the server for processing;

checking if new content is available;

selecting new updated live wallpapers from the server;

adding new live wallpapers to the local application database;

displaying new live wallpapers on a lowest visual layer of the display on a computing device using a plurality of characteristics.

In some embodiments, the computing device is a mobile computing device which has an operating system, a Wi-Fi connection or a cellular data connection.

In some embodiments, the reference to the content is at least one of an advertising background and at least one dynamic advertisement-related graphical object.

In some embodiments, the reference to the content is at least one of an advertising background and at least one animated advertisement-related graphical object.

In some embodiments, the reference to the content is at least one of an advertising background and at least one interactive advertisement-related graphical object.

In some embodiments, the characteristics include at least one of specified attribute or animating effect.

In some embodiments, the specified attribute includes at least one of position, time period, transparency or scale.

In some embodiments, the animating effect is at least one of moving, colour changing, shaking, sparkling, appearing or disappearing.

Some embodiments further comprise the step of: redisplaying a wallpaper selected from the local application database if a connection with the server cannot be established or updated content is unavailable.

In another broad aspect, the invention is said to consist in a method for using advertising live wallpaper as a screensaver on a mobile device when the device is in a charging state, in a daydream mode or docked, comprising: setting a displayed advertising live wallpaper as the screensaver on the device; displaying the advertising content on the screensaver.

In some embodiments, the mobile device is a mobile computing device which has an operating system, a touch screen, a Wi-Fi connection or a cellular data connection.

In some embodiments, the reference to the advertising live wallpaper is at least one of an advertising background and at least one dynamic advertisement-related graphical object.

In another broad aspect, the invention is said to consist in an interactive advertising content sharing system comprising: a mobile device having a display, a memory component and a processor configured to execute instructions stored on the memory component, a server having a processor and a memory component, the server memory component configured to store a plurality of advertising content comprising visual objects, one or more interaction objects and data, the server configured to link at least one sender to at least one receiver via a communication network, the server memory component further configured to store instructions for execution by the server processor operable to: receive advertising content from a mobile device of a sender, the mobile device configured or configurable to store and transmit interactive advertising content from the mobile device memory component to the server, deliver advertising content to at least one recipient user, wherein the mobile device of the recipient user is configured to receive and store the transmitted advertising content on the mobile device memory component, and implement a plurality of visual layers, retrieve one or more advertising content stored in the memory of the mobile device, and display the advertising content on a lowest layer of the visual layers.

In some embodiments, the mobile device of the recipient user is configured to send a new content request to the server, the server configured to respond by transmission of the new content to the recipient's mobile device, and display the new content on a lowest layer of the visual layers.

In some embodiments, the mobile device processor is configured to execute instructions stored on the memory component to receive a signal input from the recipient indicative of the recipient interacting with an interaction object on the live wallpaper, and, in response, initiate one or more response actions including: opening a web browser and directing to a predetermined website, showing detailed information about the displayed content, downloading a selected interactive content to the local memory of the device, skipping to the next available and stored in the local memory interactive advertising and/or returning back to the previously displayed content.

In another broad aspect the invention consists in an interactive advertising content sharing system comprising: a mobile device having a display, a memory component and a processor configured to execute instructions stored on the memory component, a server having a processor and a memory component, the server memory component configured to store a plurality of advertising content comprising visual objects, one or more interaction objects and data, at least one sender linked via the server to at least one receiver, the server memory component further configured to store instructions for execution by the server processor operable to provide the receipt and delivery of submitted and requested advertising content between at least one sender an at least one receiver, wherein the mobile device of the sender is configured or configurable to store and transmit interactive advertising content from the mobile device memory component to the server, wherein the mobile device of the recipient is configured to receive and store the transmitted advertising content on the mobile device memory component and implement a plurality of visual layers, retrieve one or more advertising content stored in the memory of the mobile device, and display the advertising content on a lowest layer of the visual layers.

In another broad aspect the invention consists in an interactive advertising content sharing system comprising: a mobile device having a display, a memory component and a processor configured to execute instructions stored on the memory component, a server having a processor and a memory component, the server memory component configured to store a plurality of advertising content comprising visual objects, one or more interaction objects and data, at least one sender linked via the server to at least one receiver, the server memory component further configured to store instructions for execution by the server processor operable to provide the receipt and delivery of submitted and requested advertising content between at least one sender an at least one receiver, wherein the server is configured or configurable to store a plurality of advertising content submitted by the sender in the form of a group created by the sender with the set of parameters, formatting and interactivity settings, wherein upon receiving a signal request from the recipient, the server then automatically transmits the interactive advertising from the server submitted by this particular sender with the pre-uploaded settings to the recipient's mobile device, wherein the mobile device of the recipient is configured to receive and store the transmitted advertising content on the mobile device memory component and implement a plurality of visual layers, retrieve one or more advertising content stored in the memory of the mobile device, and display the advertising content on a lowest layer of the visual layers.

In another broad aspect the invention consists in an interactive advertising content sharing system comprising: a mobile device having a display, a memory component and a processor configured to execute instructions stored on the memory component, a server having a processor and a memory component, the server memory component configured to store a plurality of advertising content comprising visual objects, one or more interaction objects and data, at least one sender linked via the server to at least one receiver, the server memory component further configured to store instructions for execution by the server processor operable to provide the receipt and delivery of submitted and requested advertising content between at least one sender an at least one receiver, wherein the mobile device processor is configured to execute instructions stored on the memory component to receive a signal input from the recipient of the interactive content indicative of the recipient interacting with an interaction object on the live wallpaper, and, in response, initiate one or more response actions, wherein response actions comprise one or more of opening a web browser and directing to a predetermined website, showing detailed information about the displayed content, downloading a selected interactive content to the local memory of the device, skipping to the next available and stored in the local memory interactive advertising or returning back to the previously displayed content.

The following embodiments may relate to any of the above aspects. Other aspects of the invention may become apparent from the following description which is given by way of example only and with reference to the accompanying drawings.

As used in this specification, the term “and/or” means “and” or “or”, or both.

In this specification where reference has been made to patent specifications, other external documents, or other sources of information, this is generally for the purpose of providing a context for discussing the features of the invention.

Unless specifically stated otherwise, reference to such external documents is not to be construed as an admission that such documents, or such sources of information, in any jurisdiction, are prior art, or form part of the common general knowledge in the art.

Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

This invention may also be said broadly to consist in the parts, elements and features referred to or indicated in the specification of the application, individually or collectively, and any or all combinations of any two or more of the parts, elements or features, and where specific integers are mentioned in this specification that have known equivalents in the art to which this invention relates, such known equivalents are deemed to be incorporated herein as if individually set forth.

### BRIEF DESCRIPTION OF THE DRAWINGS

The invention will now be described by way of example only and with reference to the drawings in which:

FIG. 1 is a flow chart which illustrates a method for selecting, displaying and updating advertising content on a mobile device.

FIG. 2 is an illustration of an animated advertisement being displayed as a live wallpaper on the display on a mobile device.

FIG. 3 is an illustration of how the device user can interact with the advertisement being displayed as a live wallpaper on a touch-sensitive display on a mobile device.

FIG. 4 is a flowchart showing some of the steps of user interaction with the advertisement of FIG. 3.

FIG. 5 is an illustration of a playable advertisement displayed as a live wallpaper on a touch-sensitive display on a mobile device.

FIG. 6 is a flowchart showing the process of user interaction with the playable advertisement of FIG. 5.

FIG. 7 is an illustration of an advertisement displayed on a screensaver of the mobile device once the device is in a charging state.

FIG. 8 is a flowchart showing a method for uploading and sharing advertising content to the server.

FIG. 9 is a flowchart which illustrates a method of delivering the selected content to the recipient.

### DETAILED DESCRIPTION

Mobile advertising methods in the prior art provide the consumer with little incentive to engage with an advertisement. Further, ad formats fail to communicate brand values and deliver emotion and warmth. The inventors have identified a desire in the advertising industry to provide non-intrusive dynamic, interactive and animated advertising on mobile devices that goes at least some way toward delivering the emotion and warmth presently lacking.

Touch sensitive screens of common mobile devices facilitate an improvement to user experience as it has been determined that interactive mobile advertisements provide engaging, multi-dimensional experiences where a user has a refreshing sense of control. Embodiments discussed in this specification relate to the delivery and dynamic display of interactive advertisement content on mobile computing devices by the use of screensaver or live wallpaper technology.

The term “live wallpaper” as used in this specification refers to a technology developed for mobile phones supported by Android. Starting with Android 2.0, users can enjoy live wallpapers which are operable to provide a graphics rich, animated, interactive background on the home screens of their mobile device. Live wallpaper operates similarly to a normal Android application and has access to all the facilities of the platform.

Embodiments described in this specification are operable to provide dynamic, animated and interactive advertising to mobile computing devices. The advertising is specifically targeted at the user of the mobile device and is presented to the user as live wallpaper when the device is active or as a screensaver when the device is in charging state.

A mobile device may be any portable device and optionally include a touch-sensitive display or touch-sensitive input device. For example, the mobile device can be a mobile phone, smartphone or tablet. A live wallpaper on the mobile device may be a mobile application running on the device, and it may be configured to communicate with one or more applications also running on the device, hardware components and sensors on the device, and even other devices connected with the mobile device either wired or wirelessly.

Live wallpaper generates a graphical wallpaper representation in a first process on a first visual layer on a display of a computing device, generates one or more graphical objects in a second process on a second visual layer of the display, wherein the second visual layer is positioned visually on top of the first visual layer, receives user interactions with the one or more graphical objects and generates information that reflects the user interactions, and communicates the generated information to the first process. As opposed to static wallpaper, where the display of an advertisement can be reached by just using one function on the mobile device, live wallpaper requires more complex approach from the programming perspective.

Live wallpaper enables dynamic and animated advertising to be displayed on the lowest visual layer of a display on a mobile device when the mobile device is in its active state. Advertising content can be interactive and playable and is able to be automatically updated without distracting a user of the mobile device from other tasks. Dynamic and animated advertising can also be displayed as a screensaver when the device is in a daydream mode or charging.

Live wallpaper is installed by a user in a form of mobile application or can be pre-installed and is set to be the system wallpaper for the device. Different dynamic graphical advertising objects are shown on the lowest visual layer of a display, therefore enabling animated and interactive advertising on the mobile device, at the same time having no significant impact on a user of the device.

To improve the viewability of advertisements and increase the number of guaranteed views, interactive and playable advertisements as live wallpapers on mobile devices are displayed. When a mobile device is in a charging state, daydream mode or docked, a screensaver can also display dynamic advertising that attracts a user's attention. The advertising content is updated automatically on a regular basis without any actions required from the user.

A dynamic advertising live wallpaper may advantageously have not only one graphical object, but a series of objects such as text, shapes and pictures all having different animated effects. Any one or more of such objects may have a corresponding special function that is activated when a user input is received. For example, in response to the user touching the object on the screen, open the advertisement associated web site on the mobile device or add the displayed advertisement to a fast-accessible section of the application where the user can view the advertisement later.

The live wallpaper can function as a playable advertisement where a user can interact with advertised objects to complete an entertaining activity, which is a highly effective and engaging advertising method.

In some embodiments, there is a system for providing interactive advertising content. The system will generally include one or more mobile devices having a display, a memory component and a processor configured to execute instructions stored on the memory component. For example, the mobile device could be a smart phone, tablet or other similar device typically having a touch sensitive display or a display allowing user interaction with visuals shown on the display. In some embodiments, there is a server having a processor and a memory component configured to communicate with the mobile device. For example, communication could be wired or via a wireless network such as a cellular network. The server memory component configured to store a plurality of advertising content comprising visual objects, one or more interaction objects, and data pertaining to a target recipient user for the advertising content. The server may have a database constructed to store each of the advertising content for use. The advertising content may be ordered by subject, a preferred recipient and/or for chronological deployment.

The server memory component is further configured to store instructions for execution by the server processor. The instructions relate to facilitation of receipt and storage user data pertaining to the user of the mobile device and other functions including matching received user data to advertising content. This allows users to be provided with advertising content that relates to their interests. Advertising content is transmitted from the server to a user's mobile device for display to the user. In some embodiments the user's mobile device is configured to store several items of advertising content for periodic display to the user.

In preferred embodiments, the display of the user's mobile device is configured to show at least two visual layers. The visuals layers include a low visual layer such as a background image or wallpaper, and higher visual layers that may include icons, banners and screensavers. The advertising content is configured for display on the lowest visual layer so that other graphics on one or more higher visual layers are overlaid. In some embodiments the advertising content includes interactive components such as one or more visual representations such as text, buttons and animations. The interactive components allow a user of the mobile device to selectively interact with graphics shown on the advertising content without disturbing graphics or interactive components shown on any one or more of the higher visual layers shown on the display.

In some embodiments, a user selecting an interactive component generates an instruction to the system to undertake further action or a response action. For example, further action may include opening a web browser and directing to a predetermined website, showing detailed information about the object of interest, adding a selected advertisement to a list of favourites and rating the visual representation of the displayed advertisement.

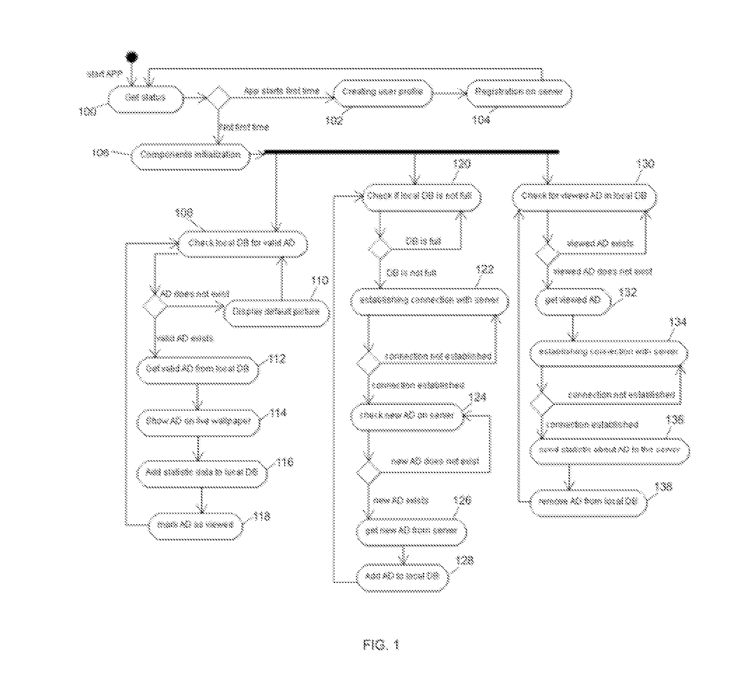

FIG. 1 shows an example of a process utilising the above described components to facilitate selecting, displaying and updating interactive advertising content on a mobile device. The users or owners of the various mobile devices will usually install advertising live wallpaper mobile application onto their respective devices or it may be preloaded by the device manufacturer or configured as to be part of the mobile device's operating system.

As part of an initializing process, the application is configured to check the status 100 if it has already been launched on the mobile device or is starting for the first time. If the application is staring for the first time, a user profile is created 102 and the system may query the user as to the user's age, sex, location (or request access to the device's GPS location data), user's interests, and other user demographic data. In some embodiments, some or all of this data is transmitted to the server 104 for storage as profile information pertaining to the user. If on checking the application status 100 it appears that the application has already been used on this mobile device and the user of the device is registered in the system, the process of components initialization 106 is started.

In some embodiments, the process undertakes the following tasks: displaying an advertisement (108, 110, 112, 114, 116, 118), updating local application database with new advertising available (120, 122, 124, 126, 128) and communicating with the server along with sending statistical data (130, 132, 134, 136, 138). The first task, which relates to displaying advertisements in a form of live wallpaper on the mobile device starts with checking local application database for valid loaded advertisements 108. If no advertisements detected in the database, a default picture is displayed 110. If there are advertisements stored in the database, which were not viewed and have not expired, then an advertisement is chosen from the database 112 and displayed as a live wallpaper on the mobile device 114. A group of statistical data is then transmitted 116 to the local application database.

The statistical data may be programmed, for example, to include reporting of mobile device usage pattern, the number of times and for how long the advertisement has been viewed by the user of the device, how often the interaction occurred between the user and the advertisement and the type of interaction, how long the mobile device is in an active or charging state, the device's location and any other related information to the local database. The application, on receiving satisfactory statistical information, marks the advertisement as shown or viewed 118.

In an exemplary embodiment, the advertisement may be considered as fully viewed when it has been viewed at least once for ten seconds or longer and then shown to the user at a regular time interval within the 24-hour timeframe.

The advertising content may feature various goods and services provided by the advertiser or merchant who can upload advertising media such as pictures, graphics or text in a predetermined format using set templates via a computer-based software application or specifically dedicated website. Advertisers and participating businesses can also upload desired targeting requirements for displaying advertisements and book a display schedule. For example, short-term sale offers can be scheduled to be displayed only for two or three days to all available users registered on the server, while advertising that promotes beer can be displayed only to the owners of mobile devices who are at least 21 years old.

Personalization is an important marketing tool today as customers expect their experiences to be tailored to their interests and preferences. In order to get the quality users that advertisers want, a focus on a target audience is required. The more targeted the advertising on audience is, the more successful marketers will be in reaching the right people.

Context is also important in advertising, as it drives relevancy for consumers. If the right tools are used to capture users' attention, the advertising campaign will have a success. In one embodiment, for the targeting purpose, a link may be established between the user's account with a social media application or website, so that content that the user generates or views on the social media site is used to generate targeted advertisements on the live wallpaper on his or her mobile device.

The second task of updating the local application database with new advertising if such advertising is available starts with checking whether the local database has a capacity for receiving new content 120. If the local live wallpaper application database is full, then the process repeats itself every 5 to 10 seconds to see whether any advertisements have been marked as viewed or expired. If capacity for receiving new advertisements exists, the application establishes a connection with the server 122. Once the connection is established, the live wallpaper application then performs the checking process on the server 124 to see whether new advertisements have been received by the server and are ready to be downloaded to the mobile device local database. When the availability of new advertisements has been confirmed, the download process is initialized 126 and new advertising content is added to the local application database 128.

The third task is to send statistical data to the server. The application regularly checks for any viewed or expired advertisements stored in the live wallpaper local database on the mobile device 130 and on existence of such advertisements 132, collects the relevant information and establishes connection with the server 134 to transmit the required statistical data to the sever 136. As soon as all the necessary information is transmitted, the application removes the expired or viewed advertisements from the local database on the mobile device 138.

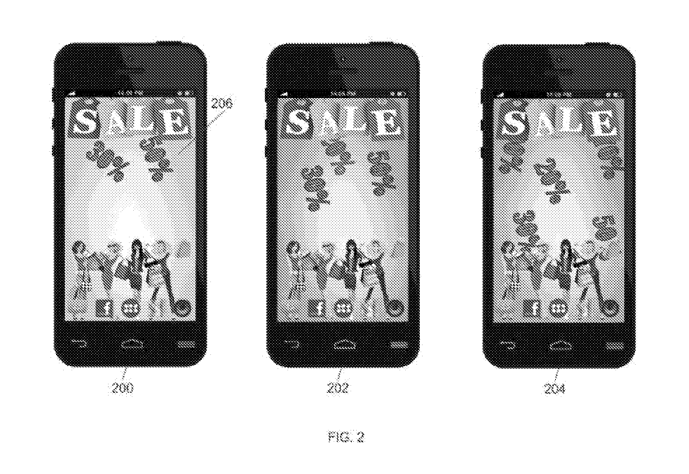

FIG. 2 shows an example of animated advertising live wallpaper displayed on the background of a mobile device 200. The second display 202 and the third display 204 of the mobile device show the dynamic movement of different graphical objects 206 on the display. According to the exemplary embodiment, a “falling” effect is applied to the graphical objects 206 which are “falling” down from the top of the screen to the bottom. The effect is applied in order to attract the attention of the mobile device user to the displayed advertisement. Each advertisement is shown for about ten seconds at a regular time interval on the screen of the mobile device when the device is in its active state. In some embodiments, different animating effects can be applied to the object or multiple objects such as sparkling, scaling, transparency, colour changing, shaking, rotation, appearing or disappearing.

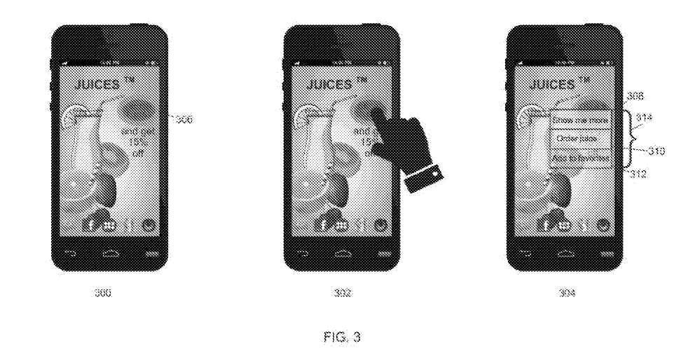

FIG. 3 illustrates another example of interactive live wallpaper with displayed advertisement 300 promoting a special offer for those who want to buy fresh juice. As an exemplary embodiment, different types of graphical objects are displayed including pictures, text and shapes. At least one of these graphical objects is an interactive object 306. The second screen 302 shows that the user can interact with the displayed objects by touching them (providing the mobile device has a touch-sensitive display or touch-sensitive input device). On touching the object and holding the finger on it for a few seconds, a drop down menu 314 may appear as shown on the third screen 304. In one embodiment, a gesture performed on the screen or another displayed object or physical button on the mobile device may also activate the menu. The user may be provided with one or more options, in this example including directing the user to the web site of the company 308 to provide him/her with some more detailed information, ordering the juice 310 or adding this advertisement to the “favourites” folder of the mobile application 312 to store the link to the advertiser's web site in the application and make it fast-accessible for a later time. However, one of skill in the art will appreciate that any number of different features could be listed herein, and the drop down menu 314 may be customized for each live wallpaper or each mobile device that runs the live wallpaper application.

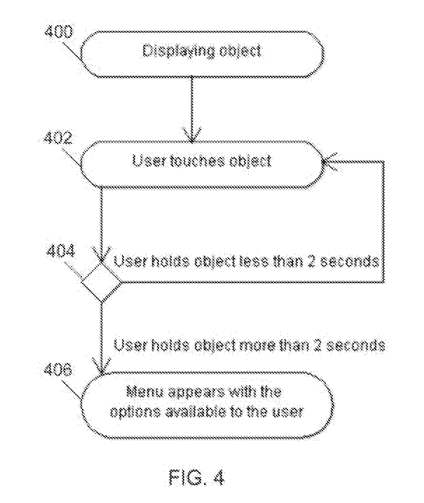

FIG. 4 shows an example of a process that facilitates advertising using the interactive live wallpaper may involve any graphical object 400 which is displayed on the background of the mobile device. Upon a user touching 402 the object 400 and holding it for at least 2 seconds 404, a drop-down menu will appear with the options available to the user 406. The options may be pre-determined by the advertiser depending on the advertised services or products.

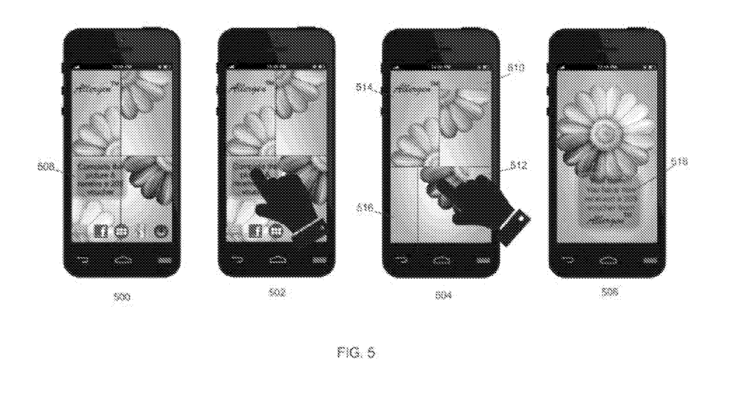

FIG. 5 illustrates an example of playable advertising live wallpaper. The first screen 500 demonstrates the advertisement which is misplaced all over the display of the mobile device. As an example, the advertiser is offering a $20 voucher to the user of the mobile device for completing an entertaining activity 508. The second screen 502 shows that the user is touching the screen, in particular, the user is clicking on the offer and presses the object for a couple of seconds. Upon receiving the signal from the user, the application opens in a new window 510 which is shown on the third screen 504.

In some embodiments, opening a new window for completing the activity may help user to avoid accidentally pressing other icons or buttons on the mobile device. However, one of skill in the art will appreciate that any number of different ways to participate in an entertaining activity. The user receives an option to rearrange the picture in the correct order by swiping 512, 516 graphical objects on the screen in four directions: to the left, right, down and up. The graphical object 514 in this example is a picture, but may include text or different shapes and may have animated effects applied to them. After completing the activity which in one embodiment may take a few seconds, the message with a reward 518 is displayed on the screen 506 and the user may have an option which without limitations may include saving it on the mobile device, view, download or forward to a friend.

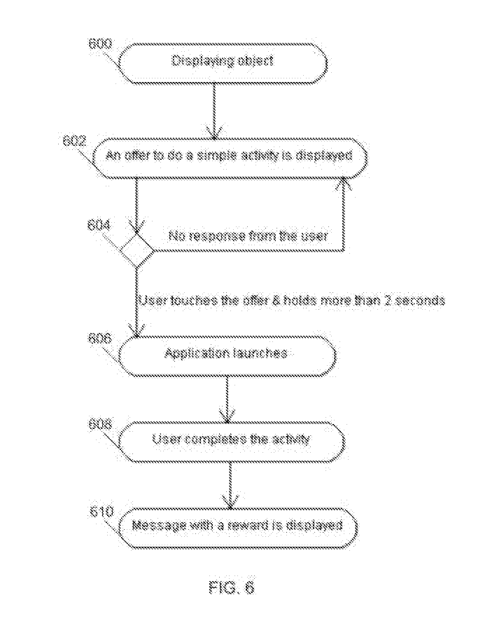

FIG. 6 shows an example process of user interaction with the playable advertisement shown in FIG. 5. At first, the live wallpaper with advertising graphical object is displayed on the mobile device 600. The live wallpaper features a promotional offer to do a simple activity 602 in a form of interactive graphical object. If no response is received from the user 604 in the case that the user is not interested in the displayed advertising, the background will change automatically in 10 seconds and a new advertisement will appear. The new advertising content may be of animated, interactive or, again, playable type. A live wallpaper application launches 606 when a signal is received indicating a user touches the screen and presses the displayed offer for more than 2 seconds. Once the user completes the activity 608, a reward message is displayed 610. The playable advertising may comprise a wide variety of games and activities such as puzzles, matching, and contests, among others.

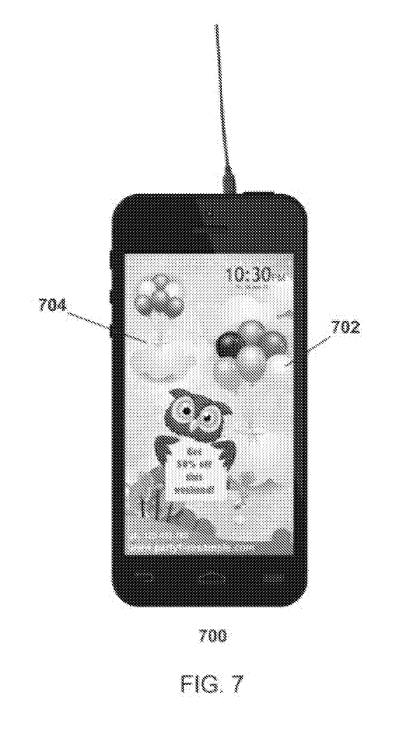

FIG. 7 illustrates an example advertisement displayed as a screensaver during one of many situations when a screensaver would be displayed on the mobile device. For example, a screensaver may be displayed when the mobile device is charging or docked 700. The screensaver 704 may be provided with the same functionality as the animated, playable or interactive advertisement displayed in the form of live wallpaper on the mobile device, including incorporated links to a website, menu options and other interactive dynamic graphical advertising objects 702.

In this example, the advertiser is the company that helps to organize parties and the balloons are slowly moving from the bottom of the screen to the top. Those skilled in the art will appreciate that the proposed method effectively attracts mobile device users' attention to the displayed ads. The method allows the displaying of relatively large graphical objects on small screens and helps making the advertiser's contact details highly noticeable.

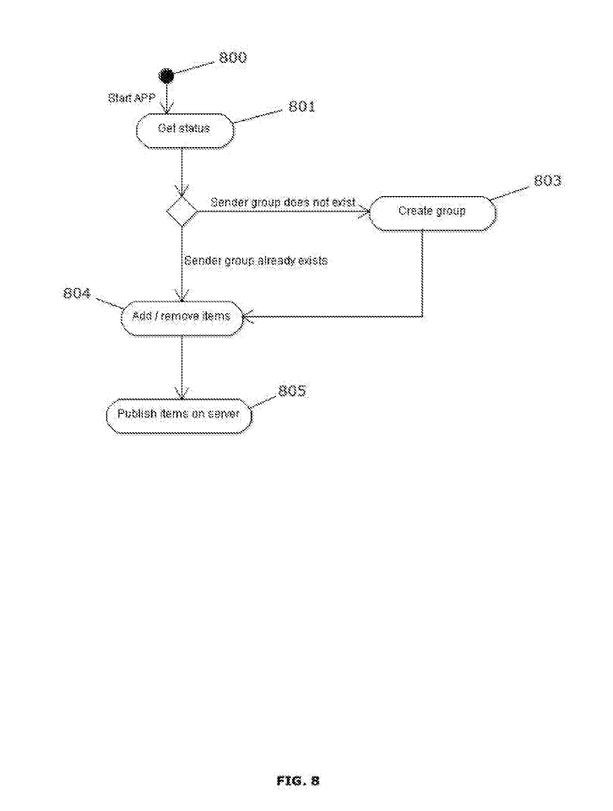

FIG. 8 illustrates an example of a process for allowing content providers to share and upload interactive advertisements to the server. A content provider may be anyone who desires to send information to the server for recall and use by others and is herein referred to as a “sender”. The depicted process is facilitated by the server enabling a communication link between itself, one or more senders and one or more end users. Generally, the server is configured to receive content from senders via a communication link, store the received content in memory, and transmit that content to end users for use as, for example, live wallpaper.

In one embodiment, a software application is provided to the system to enable a process. The software application is a number of steps or machine implementable instructions that enable the process. One process is as follows: At first, a sender of the application starts the application 800 and the application is configured to prompt the sender to enter their registration details. The application is configured to check the details provided by the sender to determine whether they have already created a group and uploaded shareable content 801. If a group does not exist, then the sender is prompted to create a new group 803 and upload content. If on checking the application status it appears that the application has already been used on this mobile device with the sender's personal information registered on the server, the sender can start uploading and formatting advertising content, add or remove items already uploaded 804. Formatting includes tasks such as cropping, adjusting visual content, adding Internet links and advertiser details to the content. Once the changes in the uploaded content have been finalised upon receiving a signal input from the sender, the content with its settings is sent to the server 805.

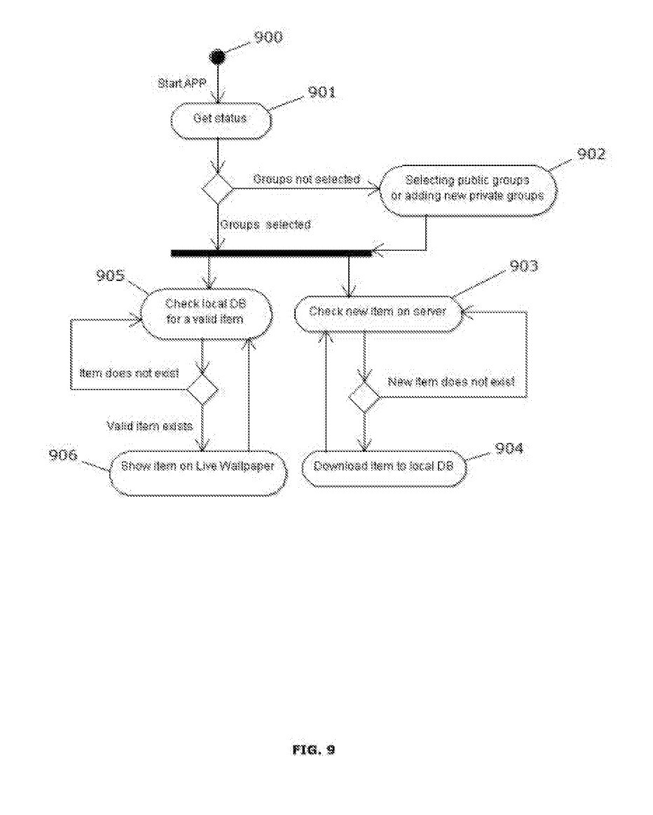

FIG. 9 shows an example of another process for delivering selected content to a recipient using live wallpaper. As above, the process is implemented by software containing machine implementable instructions. The process is as follows: At first, a user starts the application 900 and the application is configured to determine whether the application has already been launched on the mobile device or is starting for the first time 901. If the application is starting for the first time, a user profile is created. If on checking the application status it is determined that the application has already been used on this mobile device, the user is then prompted to select the content groups that will be displayed with a live wallpaper on the device. If no groups are selected, the user will then be prompted to select at least one publicly available pre-loaded group or add a new one 902. Once the groups are selected, the process of content delivery is started.

The delivery content process undertakes the following tasks: checking local mobile device for valid downloaded advertisements from the selected groups, displaying an advertisement and updating local application database with new advertising available.

The first task relates to checking for new advertisements on the server and starts with checking the server for any new content 903 uploaded in that particular group selected by the recipient and once the new content appears on the server it is then transmitted and downloaded to the local database 904.

The second task relates to displaying advertisements with a live wallpaper on the mobile device and starts with checking local application database for valid loaded advertisements from the selected group 905. If the sender has not uploaded any new advertisement and all available advertisements in the local mobile device database have been viewed based on the settings chosen by the recipient, the locally stored advertisements on the mobile device will appear on the lowest layer of the visual layers of the display using live wallpaper until a new advertisement is uploaded by the sender. Once a new advertisement is uploaded by the sender to the server, the old viewed advertisement is replaced with the new advertisement where it is displayed using live wallpaper on the recipient's mobile device 906 where they may interact with the displayed advertisement.

A group of statistical data is then transmitted to the server. The statistical data may be programmed, for example, to include reporting of mobile device usage pattern, the number of times and for how long the advertisement has been viewed by the user of the device, how often the interaction occurred between the user and the advertisement and the type of interaction, how long the mobile device is in an active or charging state, the device's location and any other related information.

In some embodiments, the number of advertisements displayed during the day may be automatically limited to a user of the mobile device. In one embodiment, a plurality of user data may be collected from the portable electronic device that will be used to determine how actively the users actually use their mobile device and a reward may be given to the user for actively viewing and engaging with the displayed advertisements. The activity can further be tracked and even made visible to the user to motivate the user to pay attention to more ads.

It should be apparent, however, to those skilled in the art that many more modifications besides those already described are possible without departing from the inventive concepts herein. The inventive subject matter, therefore, is not to be restricted except in the spirit of the disclosure.

Where in the foregoing description reference has been made to elements or integers having known equivalents, then such equivalents are included as if they were individually set forth. Although the invention has been described by way of example and with reference to particular embodiments, it is to be understood that modifications and/or improvements may be made without departing from the scope or spirit of the invention.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

1. An interactive advertising content system comprising:
a mobile device having a display, a memory component and a processor configured to execute instructions stored on the memory component,
a server having a processor and a memory component, the server memory component configured to store a plurality of advertising content comprising visual objects, one or more interaction objects, and data pertaining to a target recipient user for the advertising content,
the server memory component further configured to store instructions for execution by the server processor operable to:
receive user data pertaining to the user of the mobile device for storage on the server memory component,
determine, from the received user data, advertising content where the target recipient data matches the user data, and
transmit determined advertising content to the user mobile device,
wherein the mobile device is configured or configurable to receive and store the transmitted advertising content on the mobile device memory component, and
wherein the instructions stored on the mobile device comprise:
configuring the display to implement a plurality of visual layers,
retrieve one or more advertising content stored in the memory of the mobile device, and
display the advertising content on a lowest layer of the visual layers.

2. A system or device as claimed in claim 1, wherein the interaction object is configured for display on the lowest visual layer.

3. A system or device as claimed in claim 1, wherein the instructions for execution further comprise instructions operable to receive a signal input indicative of a user interacting with an interaction object and, in response, initiate one or more response actions.

4. A system or device as claimed in claim 1, wherein the display is touch and position sensitive and a user touch in the position of the interaction object is indicative of a user interacting with an interaction object.

5. A system or device as claimed in claim 3, wherein a response action comprises one or more of opening a web browser and directing to a predetermined website, showing detailed information about the object of interest, adding a selected advertisement to a list of favourites and rating the visual representation of the displayed advertisement.

6. A system or device as claimed in claim 1, wherein the advertising content is stored in a library of advertising content, and the instructions for execution further comprise instructions operable to store data pertaining to advertising content transmitted to the user device and, determining advertising content not transmitted to the user device for future transmission.

7. A system or device as claimed in claim 6, wherein the advertising content comprises at least one dynamic graphical object.

8. A system or device as claimed in claim 7, wherein dynamic graphical object comprises graphical changes in one or more of: position, time period, transparency, scale, rotation, colour changing, shaking, sparkling, appearing, or disappearing.

9. A system or device as claimed in claim 2, wherein the lowest visual layer is a live wallpaper.

10. An interactive advertising content system comprising:
at least one memory component and at least one processor configured to execute instructions stored on the memory component, wherein the at least one memory component is configured to store a plurality of advertising content comprising visual objects, one or more interaction objects, and data pertaining to a target recipient user for the advertising content,
the at least one memory component further configured to store instructions for execution by the at least one processor operable to:
receive user data pertaining to the user of a mobile device for storage on the memory component,
determine, from the received user data, advertising content where the target recipient data matches the user data, and
transmit determined advertising content to the user mobile device for display as one of a plurality of visual layers, wherein the advertising content is configured for display on a lowest visual layer.

11. A system or device as claimed in claim 10, wherein the interaction object is configured for display on the lowest visual layer.

12. A system or device as claimed in claim 10, wherein the instructions for execution further comprise instructions operable to receive a signal input indicative of a user interacting with an interaction object and, in response, initiate one or more response actions.

13. A system or device as claimed in claim 10, wherein the display is touch and position sensitive and a user touch in the position of the interaction object is indicative of a user interacting with an interaction object.

14. A system or device as claimed in claim 12, wherein a response action comprises one or more of opening a web browser and directing to a predetermined website, showing detailed information about the object of interest, adding a selected advertisement to a list of favourites and rating the visual representation of the displayed advertisement.

15. A system or device as claimed in claim 10, wherein the advertising content is stored in a library of advertising content, and the instructions for execution further comprise instructions operable to store data pertaining to advertising content transmitted to the user device and, determining advertising content not transmitted to the user device for future transmission.

16. A system or device as claimed in claim 15, wherein the advertising content comprises at least one dynamic graphical object.

17. A system or device as claimed in claim 16, wherein dynamic graphical object comprises graphical changes in one or more of: position, time period, transparency, scale, rotation, colour changing, shaking, sparkling, appearing, or disappearing.

18. A system or device as claimed in claim 11, wherein the lowest visual layer is a live wallpaper.

19. A mobile device comprising a display, a memory component and a processor configured to execute instructions stored on the memory component,
the mobile device configured to receive a plurality of advertising content for display comprising visual objects, one or more interaction objects, and data pertaining to a target recipient user for the advertising content,
wherein the mobile device is configured or configurable to display a plurality of visual layers, and the advertising content is adapted for display on a lowest layer of the visual layers.

20. A system or device as claimed in claim 19, wherein the interaction object is configured for display on the lowest visual layer.

21. A system or device as claimed in claim 19, wherein the instructions for execution further comprise instructions operable to receive a signal input indicative of a user interacting with an interaction object and, in response, initiate one or more response actions.

22. A system or device as claimed in claim 19, wherein the display is touch and position sensitive and a user touch in the position of the interaction object is indicative of a user interacting with an interaction object.

23. A system or device as claimed in claim 21, wherein a response action comprises one or more of opening a web browser and directing to a predetermined website, showing detailed information about the object of interest, adding a selected advertisement to a list of favourites and rating the visual representation of the displayed advertisement.

24. A system or device as claimed in claim 19, wherein the advertising content is stored in a library of advertising content, and the instructions for execution further comprise instructions operable to store data pertaining to advertising content transmitted to the user device and, determining advertising content not transmitted to the user device for future transmission.

25. A system or device as claimed in claim 24, wherein the advertising content comprises at least one dynamic graphical object.

26. A system or device as claimed in claim 25, wherein dynamic graphical object comprises graphical changes in one or more of: position, time period, transparency, scale, rotation, colour changing, shaking, sparkling, appearing, or disappearing.

27. A system or device as claimed in claim 20, wherein the lowest visual layer is a live wallpaper.

28. An interactive advertising content sharing system comprising:
a mobile device having a display, a memory component and a processor configured to execute instructions stored on the memory component,
a server having a processor and a memory component, the server memory component configured to store a plurality of advertising content comprising visual objects, one or more interaction objects and data,
the server configured to link at least one sender to at least one receiver via a communication network, the server memory component further configured to store instructions for execution by the server processor operable to:
receive advertising content from a mobile device of a sender, the mobile device configured or configurable to store and transmit interactive advertising content from the mobile device memory component to the server,
deliver advertising content to at least one recipient user,
wherein the mobile device of the recipient user is configured to receive and store the transmitted advertising content on the mobile device memory component, and
implement a plurality of visual layers,
retrieve one or more advertising content stored in the memory of the mobile device, and
display the advertising content on a lowest layer of the visual layers.

29. A system as claimed in claim 28, wherein the mobile device of the recipient user is configured to
send a new content request to the server, the server configured to respond by transmission of the new content the recipient's mobile device, and
display the new content on a lowest layer of the visual layers.

30. A system as claimed in claim 29, wherein the mobile device processor is configured to execute instructions stored on the memory component to receive a signal input from the recipient indicative of the recipient interacting with an interaction object on the live wallpaper, and, in response, initiate one or more response actions including:
opening a web browser and directing to a predetermined website,
showing detailed information about the displayed content,
downloading a selected interactive content to the local memory of the device,
skipping to the next available and stored in the local memory interactive advertising and/or
returning back to the previously displayed content.
